(19) United States
(12) Patent Application Publication
(10) Pub. No.: US 2016/0291587 A1
(43) Pub. Date: Oct. 6, 2016

(54) EVALUATING THE PERFORMANCE OF A MACHINE

(71) Applicant: TELEFONAKTIEBOLAGET L M ERICSSON (PUBL), Stockholm (SE)

(72) Inventors: Konstantinos VANDIKAS, Stockholm (SE); Dimitri MAZMANOV, Kista (SE); Farjola ZALOSHNJA, Stockholm (SE); Sébastien PIERREL, Stockholm (SE); Vlasios TSIATSIS, Stockholm (SE)

(73) Assignee: TELEFONAKTIEBOLAGET LM ERICSSON (PUBL), Stockholm (SE)

(21) Appl. No.: 15/026,922

(22) PCT Filed: Oct. 3, 2013
(86) PCT No.: PCT/SE2013/051158

§ 371 Date: Apr. 1, 2016

(51) Int. Cl. G05B 23/02

(52) U.S. Cl. CPC G05B 23/0289

(57) ABSTRACT

The invention is directed towards a machine evaluation arrangement (10) a method, computer program and computer program product for providing an indication of the functioning of a machine (26). In the arrangement product specification data for the machine (26) is obtained, the product specification data comprising technical performance data for the machine, operational data of the machine is obtained, the technical performance of the machine is evaluated with regard to the technical performance data of the specification, the technical performance of the machine being based on said operational data, and an indication of the functioning of the machine is provided based on the evaluation.

### TECHNICAL FIELD

The invention relates to a machine evaluating arrangement, a method, computer program and computer program product for providing an indication of the functioning of a machine.

### BACKGROUND

For a machine there is often provided product specification data. Product specification data is also often provided in the form of data sheets and comprises technical performance data where various operational parameters are specified.

The performance in a data sheet is a general information that has been determined for a machine through testing in a special test environment.

However, it may be of interest to know how well a specific machine operates or a group of machines operate compared with the specification in an operational environment, i.e. in a environment in which the machine is operated.

One way in which the functioning of a specific machine is compared with how it should operate is through a user of the machine performing a rating.

The user may for instance give a review, where machines are evaluated based on
1. free-text—a liberal description based on a user's personal bias that describes the user's experience
2. a 1-5 star rating that aims at quantifying the user's experience

Moreover, if a product is running a piece of software, service oriented architecture (SoA) contains approaches that allow for recording and sending usage reports to the manufacturer of the software in the context of improving user experience.

The manufacturer collects these reports (also known as usage data) and uses them internally in order to improve that software.

There are however two problems with the above-mentioned approaches. A first problem is that they typically require user involvement in order to provide the above mentioned feedback. A user of a machine may thus have to actively provide data that is fed back to the provider. This is something a user may be unwilling to do. If there are many machines it may also be practically impossible. A second problem is that the above-mentioned type of feedback is biased. It is the user experience of the functioning that is returned. This is highly personal. One user may for instance give a bad rating to a faultless machine, while another may give a high rating to a machine that does not function satisfactorily.

There is therefore a need for allowing the functioning of a machine as compared with the specification of the machine to be obtained, in a simple, user friendly and unbiased way.

### SUMMARY

One object of the invention is thus to obtain a comparison of the functioning of a machine with the specification of the machine in a simple, user friendly and unbiased way.

This object is according to a first aspect of the invention achieved by a machine evaluation arrangement for providing an indication of the functioning of a machine. The machine evaluation arrangement comprises a machine evaluation device comprising a processor and memory, where the memory contains computer instructions executable by the processor. Through these instructions, the machine evaluation device is operative to obtain product specification data for the machine, where the product specification data comprises technical performance data for the machine, obtain operational data of the machine,

evaluate the technical performance of the machine with regard to the technical performance data of the specification, where the technical performance of the machine is based on the operational data, and provide an indication of the functioning of the machine based on the evaluation.

This object is according to a second aspect also achieved by a method for providing an indication of the functioning of a machine. The method is performed in a machine evaluation arrangement and comprises obtaining product specification data for the machine, where the product specification data comprises technical performance data for the machine, obtaining operational data of the machine,

evaluating the technical performance of the machine with regard to the technical performance data of the specification, where the technical performance of the machine is based on the operational data, and providing an indication of the functioning of the machine based on the evaluation.

The object is according to a third aspect achieved through a computer program for providing an indication of the functioning of a machine. The computer program comprises computer program code, which when run in a machine evaluation device of a machine evaluation arrangement, causes the machine evaluation device to:

obtain product specification data for the machine, where the product specification data comprises technical performance data for the machine, obtain operational data of the machine,

evaluate the technical performance of the machine with regard to the technical performance data of the specification, where the technical performance of the machine is based on the operational data, and provide an indication of the functioning of the machine based on the evaluation.

The object is according to a fourth aspect furthermore achieved by a computer program product for providing an indication of the functioning of a machine. The computer program product is provided on a data carrier and comprises the computer program code according to the third aspect.

The invention according to the above-mentioned aspects have a number of advantages. Since it is based on collected operational data, the provided indication is unbiased. There is no need for user involvement and therefore it is also user friendly. It is furthermore easy to implement, since many machines already have the ability to communicate.

In an advantageous variation of the first aspect, the machine evaluation device is further operative to process the operational data in order to obtain a value of the technical performance to be used in evaluating.

In a corresponding variation of the second aspect, the method further comprises processing the operational data in order to obtain a value of the technical performance to be used in the evaluating.

There may furthermore exist various types of processing available for the evaluating.

According to a further variation of the first aspect, the machine evaluation device is further operative to choose at least one type of processing to be used in the evaluating.

According to a corresponding variation of the second aspect, the method further comprises choosing at least one type of processing to be used in the evaluating.

Some examples on the types of processing comprise statistical processing and frequency domain processing when the operational data is time domain data.

According to yet another variation of the first aspect, the machine evaluation device is further operative to obtain a processing type selection from a provider of the product specification data and when being operative to choose is operative to choose the at least one type of processing based on the obtained processing type selection.

According to a corresponding variation of the second aspect, the method then comprises obtaining a processing type selection from a provider of the product specification data, where the choosing comprises choosing the at least one type of processing based on the obtained processing type selection.

According to a further variation of the first aspect, the machine evaluation device when being operative to evaluate is operative to compare the value of the technical performance with the technical performance of the specification.

According to a corresponding variation of the second aspect, the evaluation then comprises comparing the value of the technical performance with the technical performance of the specification.

According to a yet a further variation of the first aspect, the machine evaluation device when being operative to compare is operative to determine a difference between the value of the technical performance of the machine and a value of the technical performance of the specification and to compare the difference with an allowed deviation and when being operative to provide an indication of the functioning of the machine is operative to provide an indication of if the difference is an allowable difference or not

According to a corresponding variation of the second aspect, the comparing comprises determining a difference between the value of the technical performance of the machine and a value of the technical performance of the specification and comparing the difference with an allowed deviation and the providing of an indication of the functioning of the machine comprises proving an indication of if the difference is an allowable difference or an unallowable difference.

According to yet another variation of the first aspect, the machine evaluation device is further operative to perform control of the machine if the indication is an indication that the difference is an unallowable difference.

According to a corresponding variation of the second aspect, wherein if the indication is an indication that the difference is an unallowable difference, then the method further comprises performing control of the machine.

The control may comprise updating the machine, for instance through providing software updates or new operating parameter settings. It may also comprise denying the machine the ability to communicate in a communication network.

The machine may be a piece of consumer electronics. It may also be a vehicle. As another alternative the machine may be n e-health device.

The technical data may comprise measurements of at least one physical property of the machine and the machine evaluation arrangement may comprise a measurement database in which the physical property measurements are stored.

The machine evaluation arrangement may further comprise an indication database and the machine evaluation device may be further operative to store the indication in the indication database.

The machine evaluation device may be a machine evaluation server. It may also be a sensor device associated with the machine.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The invention will now be described in more detail in relation to the enclosed drawings, in which:

FIG. 1 schematically shows a machine evaluation arrangement communicating with vendor entitles and machines in order to provide indication of how the machines operate,

FIG. 2 schematically shows a first realization of machine evaluation device of the machine evaluation arrangement,

FIG. 3 shows a block schematic of a second realization of the machine evaluation device,

FIG. 4 shows a flow chart of a first embodiment of a method for providing an indication of the functioning of a machine being performed in the machine evaluation arrangement,

FIG. 5 shows a flow chart of a second embodiment of a method for providing an indication of the functioning of a machine being performed in the machine evaluation arrangement,

FIG. 6 shows a flow chart of a number of method steps that are used to provide a machine with changed operational settings based on the evaluation,

FIG. 7 shows signals exchanged between various entities in FIG. 1 in order to implement the functionality of the second embodiment, and

FIG. 8 shows a computer program product comprising a data carrier with computer program code for implementing the stream processing handling arrangement.

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits and methods are omitted so as not to obscure the description of the invention with unnecessary detail.

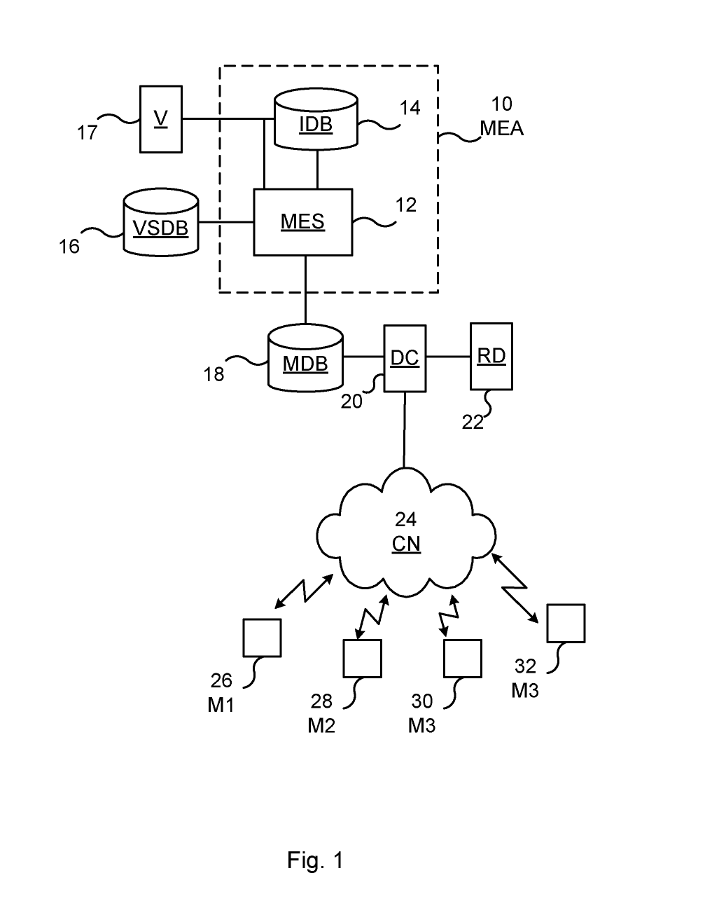

In FIG. 1 there is shown a machine evaluation arrangement 10. The machine evaluation arrangement 10 comprises a machine evaluation server MES 12 being connected to an indication database IDB 14. The machine evaluation server 12 is furthermore connected to a vendor device V 17 and to a vendor specification data base VSDB 16. The vendor device 17 and the vendor specification database 16 are two different vendor entities. A vendor specification database 16 is here a database comprising product specification data about machines provided by the vendor, while the vendor device 17 is a device via which the vendor may access the machine evaluation device 12. The vendor device 17 is also shown as being connected to the indications database 14. The machine evaluation device 12 is furthermore connected to a measurement database 18, in which data about a number of machines is stored. The data may comprise a collection of measurements from several vendor-specific machines, such a rotational speed of a hard disk drive, energy consumption (idle-time, heavy-load) and sensor readings, such as temperature. The machine evaluation server 12 is connected to a data collector DC 20, which in turn is connected to a resource directory RD 22 as well as to machines via a communication network CN 24. The Resource Directory 22 may be used for device discovery in order to be able to perform polling of machines and also for the purposes of actuation, in order to interact, send commands to external devices.

As an example there is here a first machine M1 26, a second machine M2 28, a third machine M3 30 and a fourth machine M4 32 connected to the 20 communication network 24. The communication network 24 is with advantage a wireless communication network and may be any type of wireless network such a mobile communication network, a WLAN network or a Wireless sensor network, such as a WirelessHart or a ZigBee network.

In one variation the machine evaluation server is a machine evaluation device. In other variations, the measurement database may comprise functionality providing a machine evaluation device. In yet other variations, a sensor device associated with a machine, which may be connected to a machine or be a part of machine, is a machine evaluation device.

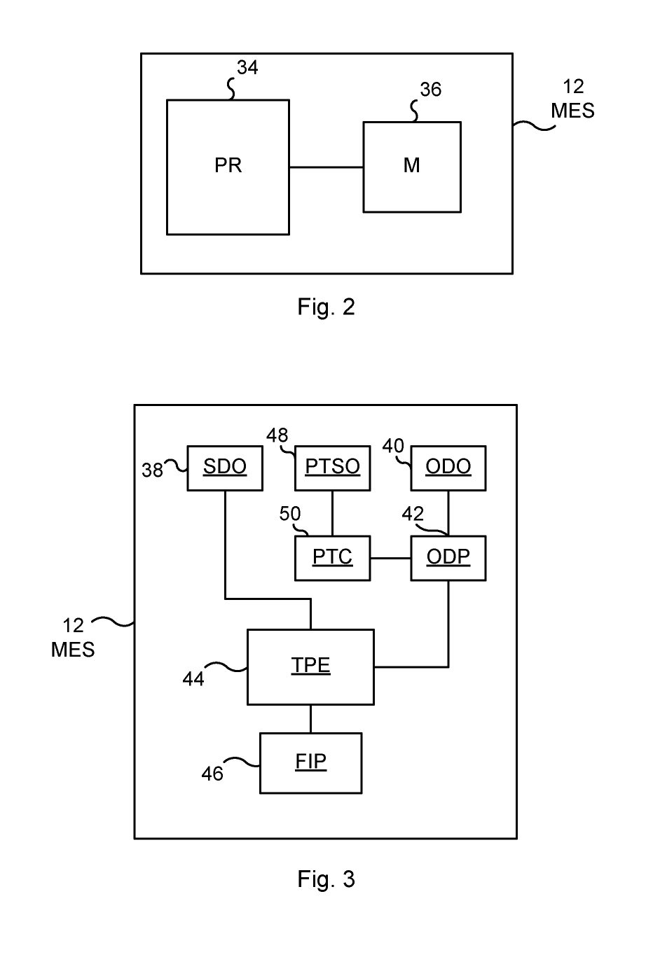

FIG. 2 shows one implementation of the machine investigating server MES 12. In this variation it comprises a processor PR 24 with associated program memory M 36, in which memory 36 program instructions for performing the functionality of the machine evaluating device are stored.

FIG. 3 shows a block schematic of another variation of the machine investigating server 12. The machine investigation server 12 may also be considered to comprise a number of units, which may be software units or one or more hardware units, such as special purpose hardware units, like 10 application specific integrated circuits (ASICS) or field programmable gate arrays (FPGA). The above-mentioned units do in one variation comprise a specification data obtainer SDO 38, which is connected to a technical performance evaluator TPE 44. The units furthermore comprise an operational data obtainer ODO 40, which is connected to an operational data processor ODP 42. The operational data processor 42 is connected to the technical performance evaluator 44. There is furthermore a processing type selection obtainer PTSO 48, which is connected to a processing type chooser PTC 50. The processing type chooser 50 is connected to the operational data processor ODP 42. Finally there is a functioning indication provider FIP 46 connected to the technical performance evaluator 44. It should here be realized that in some variations of the server, the processing type selection obtainer 48 may be omitted. Also the process type chooser 50 may be omitted. Even the operational data processor 42 may be omitted.

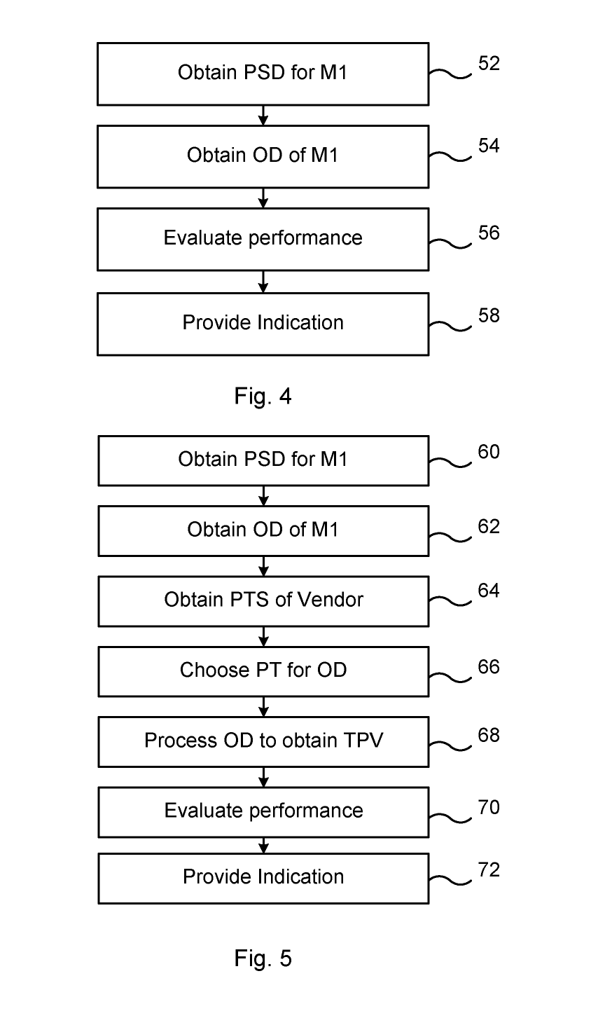

Now a first embodiment will be described with reference also being made to FIG. 4, which shows a flow chart of a number of method steps in a method for providing an indication of the functioning of a machine being performed in the machine evaluation arrangement.

The machines 26, 28, 30 and 32 in the network 24 may be machines that are provided by a vendor and may as such be set to perform one or more tasks. With the machines are also associated product specification data or technical specifications. These technical specifications specify the functioning of the machines and more particularly comprise technical performance data specifying how machines are supposed to operate at various operating conditions. These specifications may have been obtained via testing of a machine in a special testing environment. These specifications are also stored in the vendor database 16.

Now assume that someone, the vendor or some other party, such as an owner or operator of the first machine M1 wants to find out how well this first machine is operating, i.e. how well the machine lives up to the technical performance data of the technical specification.

The arrangement 10 is provided for providing an indication of the functioning of one or more of the machines with regard to the product specification. For this reason the specification data obtainer 38 of the machine evaluating server 12 obtains product specification data PSD for a machine, such as the first machine M1, step 52. This may be done through the specification data obtainer 38 connecting to the vendor specification database 16 and fetching data about the first machine M1. The data being obtained furthermore technical performance data of the machine, which technical performance data is provided in product specification data for the machine. This technical performance data is to be compared with technical performance data obtained via the operational data from the machine.

In order to enable this, the operational data obtainer 40 of the machine evaluating server 12 obtains operational data OD of the first machine M1, i.e. data obtained while the machine M1 is in operation in an operational environment, step 54.

This operational data may be obtained in a number of ways. In the example shown in FIG. 1, the data collector 20 may continually collect data of the operation of the machines and store in the machine database 18. In this case the operational data obtainer 40 may connect to this database 18 and obtain operational data of the first machine 26. As an alternative the operational data obtainer 40 may send a request to collect operational data from or about the first machine 26. This request may be sent to the data collector 20, which may need to identify the location of the machine 26 in the resource directory 22 and then connect to the machine 26 and fetch data therefrom. The data collector 20 may then collect operational data in a push or poll based manner. By push is understood that a machine or a sensor device connected to the machine proactively pushes information to be stored in the measurement database 18. By poll is understood that the data collector 20 periodically polls the machine or the sensor connected to the machine in order to retrieve the operational data it has recorded since the last polling. The data collector 20 may then return the data to the operational data obtainer 40. Alternatively the operational data obtainer 40 may in some instances communicate directly with the first machine 26 and collect data from it. This may be the case if the operational data obtainer 40 has access to a wireless interface via which it may communicate directly with various machines and has knowledge of an identity of the first machine such as a phone number of the machine in a mobile phone network.

The operational data is then used for evaluating the performance of the machine compared with the technical performance of the product specification data. In order to allow the evaluation to be performed, the specification data obtainer 38 forwards the obtained technical performance data of the specification to the technical performance evaluator 44 and the operational data obtainer 40 provides the operational data of the first machine 26 for use in the evaluation. This evaluation is performed in the technical performance evaluator 44, where the performance of the first machine 26 is evaluated using the collected operational data. The technical performance evaluator 44 thus implements functions/algorithms for producing evaluation results by comparing operational data such as measurement values in the measurement database 18 with reference specification values as described in the vendor specifications database 16. In some instances the collected operational data may be directly used as a measure of the technical performance that is to be compared with the technical performance data of the product specification. The operational data may thus comprise a technical performance value. In this case the operational data obtainer 40 would send the operational data directly to the technical performance evaluator 44. In other instances some processing may be performed on the operational data before being evaluated. In this case the operational data is thus processed in order to obtain a value of the technical performance to be used in evaluating. In this case the operational data obtainer forwards the operational data to the operational data processor 42, which processes the operational data in order to be compared with the technical performance data.

The processing may be a processing such as an averaging of results. It may also comprise interpolation or extrapolation. It may furthermore be a more refined processing. The data may for instance be time domain data such as data collected at regularly repeated points in time. This time domain data may then be transformed to the frequency domain, frequency domain processing applied on the data, which is possibly followed by transforming back to the time domain. In order to be able to perform such processing, Fourier or inverse Fourier processing techniques may be used. Through the processing it is then possible that a value of the technical performance of the machine is obtained.

The technical performance value, either the unprocessed original operational data or the processed operational data, is then compared with the technical performance data of the specification by the technical performance evaluator 44, in order to evaluate the performance of the first machine 26 with regard to the technical performance data of the specification, step 56, where the technical performance of the machine is based on the operational data. The results of the evaluation are then provided to the function indication provider 46. The function indication provider 46 provides an indication of the functioning of the first machine 26 based on the evaluation, step 58, for instance via an indication of how well the technical performance value matches the technical performance data of the specification.

The indication may be provided through the technical performance value being in an interval around a nominal value specified by the technical performance data of the specification, or a value that is above or below the nominal value. There may also various degrees of correspondence indicated. There may for instance be intervals of increasing size corresponding to different degrees of correspondence. There may also be different indications based on how much below or above the nominal value the performance value is provided.

Once an indication has been determined, it may then be stored in the indication database 14, where the vendor may see it. This may be of interest if the indication is to be used in further development of the machine type or in correcting faults. It should also be realized that the indication may also be provided to the machine or an owner or operator of the machine.

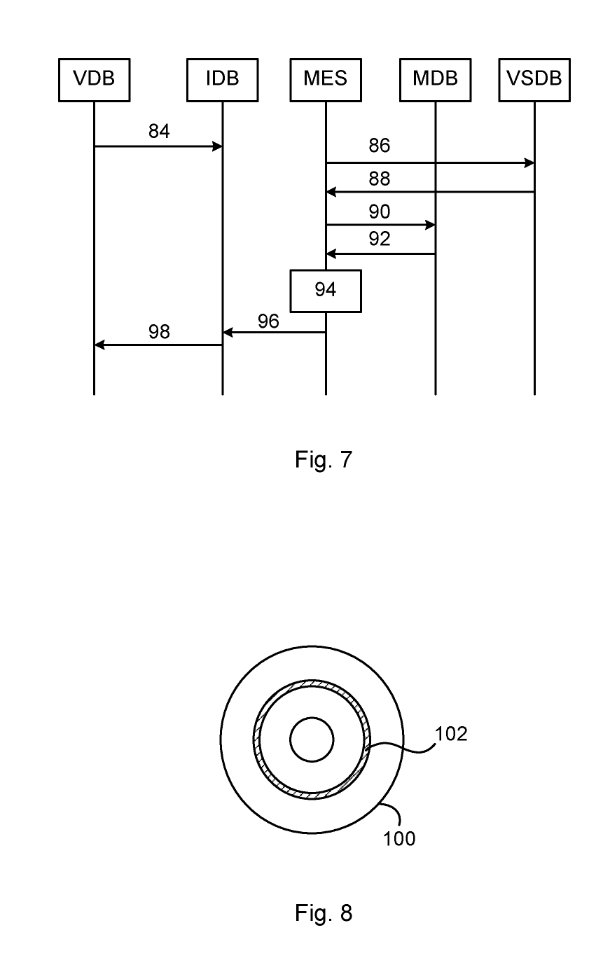

Now a second embodiment will be described with reference being made to FIGS. 1, 3, 5 and 7, where FIG. 5 shows a flow chart of method steps in a method for providing an indication of the functioning of a machine, which steps are performed in the machine evaluation arrangement 10 and to FIG. 7, which shows signals exchanged between the vendor device 17, the indication data base, the machine evaluating server 12, the measurement database 18 and the vendor database 16 in the method of the second embodiment.

In this example the vendor, via the vendor device 17, requests an evaluation of a machine. This may be done through the vendor, sending via the vendor device 17, a request 84 for subscribing to evaluation results of machines of a certain type. It is here assumed that the first machine 26 is of this vendor selected type. This request 84 may be sent to the indications database 14. The machine vendor may interact with the indications database 14 of the machine evaluating arrangement 10 by means of a publish/subscribe mechanism. Such an interaction mechanism may be in the form of a database trigger such as a relational database management system (RDBMS) type of trigger. Different mechanisms can be used in order to trigger the evaluation cycle such as direct commands originating from the vendor, or periodic, scheduled calls that aim at measuring a particular portion of data (i.e. daily/monthly/yearly evaluation results). A request may thus trigger the start of an evaluation. As an alternative an evaluation may be a continuous process being performed with regard to machines, for instance machines of specific types. The data collector 20 may for this reason regularly collect operational data from the machines. The data collector 20 may for this reason cooperate with the resource directory 22 in order to collect information from the machines. As an alternative a machine may be set to generate operational data when it is in operation and then report this operational data to the data collector 20.

This also means that the machine evaluating device 12 may receive notice of the desire of the vendor to obtain evaluations or it may not receive any such notification. The latter case is shown in FIG. 7. An indication concerning a machine or a group of machines, such as machines of a certain type, may thus be provided as a response to a request or independently of if such a request is received or not.

The specification data obtainer 38 then obtains product specification data PSD concerning the machines of the machine type from the vendor specification database, step 60. As the first machine 26 is of the vendor selected type, the obtained product specification data is also product specification for the first machine 26. The product specification data may be obtained through the specification data obtainer 38 sending a query 86 about the product specification for a machine of the above-mentioned vendor specified machine type, and receiving a response 88 with the product specification data of the machine type.

For the machines of the vendor selected type, the operational data obtainer 40 then obtains operational data, step 62, and as the first machine 26 is of this type, the obtained operational data comprises operational data of the first machine 26. Operational data may be obtained through the operational data obtainer 40 sending a query 90 concerning the device type to the measurement data base 18 and receiving a response 92 with operational data of all the devices of the device type, which is here exemplified by the first device M1. Once the evaluation cycle is triggered by the vendor, the operational data obtainer 40 may thus be set to retrieve data from the measurement database 18. This may be done using a function call “Get Data by Device Type”, which function may be formed as a normal query in a DBMS, document based, or even key value based data storage mechanism. The filtering of the query is in this case by device type. It should however be realized that other kinds of filters such as per manufacturer, time of the day or even for more specific data could be used instead or in addition. Once the measurement database 18 receives this query it responds back with a list of data.

The operational data does in this embodiment require processing in order to be possible to compare with the specification. There may in this regard exist a number of different types of processing that are available, such as frequency domain processing, statistical processing such a processing based on least squares, interpolation or extrapolation. There may thus exist various types of processing that are available for the evaluating It is furthermore possible that the vendor has to specify the type of processing that should be performed. A processing type selection or indication may be a part of the previously described subscription made by the vendor via the vendor device 17. In this case the processing type selection obtainer 48 connects to the indications database 14 and receives the processing type selection of the vendor. As an alternative the processing type selection obtainer 48 may connect to the vendor device 17 with a question about processing type, where the vendor may respond with a processing type selection. As yet another alternative the type of processing required may be indicated in the product specification data, in which case the processing type selection obtainer 48 may connect to the vendor database 16 or request the specification data obtainer 38 to provide it with the selection or data that may be used for selecting processing type and obtain the processing type selection therefrom. The processing type selection obtainer 48 may thus make a request to the Vendor specifications database. The response of this request may in some instances furthermore contain information about which rules or functions to be used by the operational data processor 42 in order to evaluate the particular data set of operational data. This may be implemented by a piece of software that is transmitted from the vendor specification database 16 to the processing type selection obtainer 48, which in turn forwards it to the operational data processor 42, for being executed within the operational data processor 42 to achieve this kind of processing. The processing type selection is thus obtained from the vendor, i.e. from the provider of the product specification data, by the processing type selection obtainer 48, step 64, which may be done in any of the above described ways.

The selection may then be forwarded from the processing type selection obtainer 48 to the processing type chooser 50, which processing type chooser 50 then chooses a processing type for the operational data, step 66, and informs the operational data processor 42 about the chosen processing type, which choosing may thus be a choosing of the at least one type of processing based on the obtained processing type selection. The processing type chooser 50 may thus choose at least one type of processing to be used in the evaluating. Alternatively the processing type chooser 50 may receive software implementing the processing and install this software in the operational data processor 42 for being used in the processing of the operational data.

Thereafter the machine evaluation server 12 handles 94 the obtained data in order to provide an indication.

In this handling, the operational data processor 42 first processes the operational data from the machines of the specified type, i.e. also of the operational data from the first machine 26 in order to obtain a technical performance value TPV for each machine, step 68, which processing may involve integration, derivation, least-square processing, interpolation, extrapolation etc. Processing may also mean the usage of different other functions such as MIN, MAX, AVG etc. in order to figure the minimum, maximum or average value respectively in a set of data or more complex functions such as frequency domain processing, for instance in the form of fast-Fourier transformations (FFTs) to identify more intricate patterns or create signatures of data. The result of the processing is a technical performance value TPV that is to be used in a comparison with the technical performance data of the product specification data.

For this reason the technical performance value TPV for each machine in the group is forwarded from the operational data processor 42 to the technical performance evaluator 44, which evaluates the technical performance of a machine, such as the first machine 26, through comparing the technical performance value TPV with the technical performance of the product specification data, step 70. The technical performance of the product specification may specify a nominal technical performance value. These two values may be used to obtain a difference in performance ΔTP. The comparison may involve seeing if the technical performance value TPV is above or below the corresponding nominal value of the technical performance in the specification, i.e. if there is a positive or negative difference ΔTP. The amount with which it is above or below may also be determined, i.e. the size of the difference. Such a comparison may be made for every machine in the group, i.e. for every machine of the vendor selected type.

Thereafter the results of the comparison are provided to the functioning indication provider 46, which provides an indication about how well the specification is met for a machine being evaluated, step 72, for instance in the form of a rating, perhaps as an integer between 1 and 5 or a as a letter being A-D, which rating may then be stored in the indications database and published to the machine vendor. A rating may thus be a Live Usage Rating: (LUR), i.e. a parameter that is calculated by the evaluation results based on formulas such as weighted average and represented as a 0.1 or 1.5 rating. The rating is performed for all machines of the specified type.

As the vendor subscribed to the evaluations, the evaluation results will then be reported 98 to the vendor.

The method according to the second embodiment described above is an offline evaluation process where the machine evaluating server proactively requests for large chunks of data to be evaluated. Other kinds of evaluation such as online evaluation are also possible using the proposed mechanism. The key difference with such kinds of processing would be that the requests between the machine evaluating server and the databases are more frequent and as such the machine evaluating device gains the ability to work with the deltas between different data sets instead of re-computing everything. Another possible variation would be to have a push-based relationship between the machine evaluating server and the measurement database instead of polling. This would allow the measurement database to provide updates to the machine evaluating device whenever such are available.

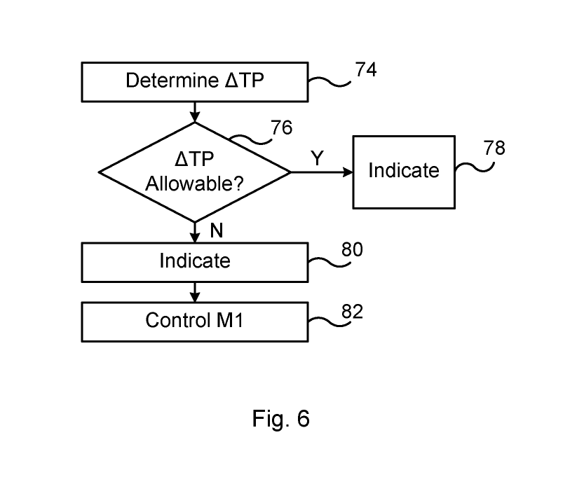

It is in some cases of interest to actively use the difference in performance, wherein one way is shown in a flow chart in FIG. 6. The difference ΔTP between the calculated technical performance value and the nominal performance value is determined in the evaluator, step 74. This difference may be compared with an allowed deviation, and if the difference is inside the allowed deviation, i.e. the difference is allowable, the functioning indication provider 46 may provide an indication in the previously described way, step 78. However the difference may also be outside of the allowed deviation, it may thus also be unallowable. The difference may for instance be too large, which may also be indicated by the functioning indication provider 46, step 80. However the machine in question may need to change its operation. For this reason the arrangement may control the machine. The control may involve providing changes of the machine. Changes may comprise changed operational parameter settings. It is also possible that software updates are provided so that the machine operates in a better way.

Another type of control is the stopping of the machine from communicating in the network

As can be seen the above described variations, suggest collecting usage data, i.e. operational data, from many machines, using sensor functionality for instance implemented using client software in the machine or in devices such as computers associated with the machines. The the operation of machines is furthermore monitored and a calculation being made of how well these machines behave, for instance based on the amount of malfunctions or amount of service repairs it has required.

The evaluation of machines can be performed for a number of different fields such as consumer electronics, transportation, medical devices and industrial equipment.

A machine may for instance be a consumer device, such as a hard disk drive. Assume as an example this hard disk drive has product specification data specifying a read speed of up to 555 MB/s at least in extreme heavy-duty operations. If a sensor device is a computer connected to a first machine being this type of disk drive, where the computer has a simple piece of software installed that obtains operational data through measuring the actual read speed of the hard disk drive, it is possible to collect and transmit actual read speeds in normal scenarios done by average users. This information is collected and can later on be grouped in percentiles. Any IP-based protocol can be used in order to transmit this operational data from the hard-drive. The realization, that one could possible make is that even though this hard-disk drive has a rather high read speed, on average most users don't utilize it because normal day-to-day requirements are less demanding. Therefore a user can be without bias lead to the decision of purchasing a cheaper and less powerful hard drive. Other characteristics of the hard drive can be assessed in the same fashion.

Another example, again from the area of consumer electronics is a Nest thermostat that supports Zigbee. This thermostat has a certain measuring capacity, say between −100 to +100 degrees Celsius. By collecting historical information from several deployments of such a thermostat and if an outlier measurement (<−100 or >100) is identified then a misbehaving nest has been identified that could later on lead to more educated decision about how frequently such thermostats misbehave.

Remaining in the area of consumer electronics it is possible to envision similar kinds of detection/accumulation/recommendation that can be done in washing machines, refrigerators, ovens, coffee machines etc. For example it is possible to measure actual electricity consumption of such devices as opposed to what the manufacturer is actually claiming, water consumption and even other kinds of malfunctions.

Moving on to transportation, it is possible to measure actual fuel consumption of people using a specific vehicle, living in the same area, perhaps working in the same area, and be single/or have a family as opposed to average fuel consumption that the vehicle manufacturer is promising. Similar measurements (and recommendations) as a consequence can be made for fuel emissions.

As one variation, the measurement database, data collector and resource directory may be replaced by a service delivery platform, such as the Service Enablement Platform provided by Ericsson. Thereby already existing entities that offer similar functionality to what a Resource Directory, a Data Store and Data collection mechanism offers may be used. Moreover, by means of the resource directory it is possible to acquire direct access to an external machine endpoint and using that transmit commands that allow for remote operations on top of that machine.

The following non-limiting additional examples of use of the machine investigating arrangement have been identified.

By identifying how a connected machine, for example how much is required on average by the different applications that are being used by a user on a smartphone, one can determine at the network level in which kind of network that machine can be connected (i.e. LTE, WIFI, PICO, Peer-2-Peer). Once that is determined a command can be send to the machine enforcing the decision.

Evicting misbehaving machines—By determining the amount of requests being made from a connected machine to a network one can determine if the machine has been hijacked and if it is used for the purposes of creating a denial of service in attack in a network. If that is the case, the machine investigating arrangement can be used in order to evict such machines.

The machine investigating arrangement can be used for the purposes of doing patches and updates—The machine investigating arrangement may in particular be used in order to identify at the network level of those machines that require an update, by viewing the software version that is running on a connected machine and therefore recommend or even enforce a software update to take place on the machine.

In the automotive industry, the machine investigating arrangement can be used in order to remotely identify possible problems in vehicles, (such as malfunctioning breaks, or an expectedly low levels of engine oil) and remotely disable a vehicle to prevent possible accidents.

The machine may also be an e-health device, for instance a device measuring a property of a human body, such as pulse and/or blood pressure and reporting the measurement to a health server via the communication network. Such an e-health device may receive an update if it sin not functioning properly.

The arrangement may, as was mentioned initially, be provided in the form one or more processors with associated program memories comprising computer program code with computer program instructions executable by the processor for performing the functionality of the traffic distribution layer.

The computer program code of a machine investigating arrangement may also be in the form of computer program for instance on a data carrier, such as a CD ROM disc or a memory stick. In this case the data carrier carries a computer program with the computer program code, which will implement the functionality of the above-described stream processing handling arrangement when being implemented in a machine evaluation device. One such data carrier 100 with computer program code 102 is schematically shown in FIG. 8.

Furthermore the specification data obtainer may be considered to form means for obtaining product specification data for a machine, where the product specification data comprises technical performance data for the machine, the operational data obtainer may be consider to form means for obtaining operational data of the machine, the technical performance evaluator may be considered to form means for evaluating the technical performance of the machine with regard to the technical performance data of the specification, where the technical performance of the machine is based on the operational data and the functioning indication provider may be considered to form means for providing an indication of the functioning of the machine based on the evaluation.

The operational data processor may further be considered to form means for processing the operational data in order to obtain a value of the technical performance to be used in evaluating.

As there may exist various types of processing available for the evaluating, the processing type chooser may be considered to form means for choosing at least one type of processing to be used in the evaluating.

The processing type selection obtainer may further be considered to form means for obtaining a processing type selection from a provider of the product specification data and the means for choosing at least one type of processing to be used in the evaluating may be means for choosing the at least one type of processing based on the obtained processing type selection.

The means for evaluating the performance may comprise means for comparing the value of the technical performance with the technical performance of the specification, which may comprise means for determining a difference between the value of the technical performance of the machine and a value of the technical performance of the specification and means for comparing the difference with an allowed deviation, while the mans for providing an indication of the functioning of the machine may be means for providing an indication of if the difference is an allowable difference or not.

The machine evaluation arrangement may further comprise means for updating the machine if the indication is an indication that the difference is an unallowable difference.

While the invention has been described in connection with what is presently considered to be most practical and preferred embodiments, it is to be understood that the invention is not to be limited to the disclosed embodiments, but on the contrary, is intended to cover various modifications and equivalent arrangements.

It is for instance possible that the machine evaluation device of the arrangement is a sensor device associated with a machine or is a sensor device being a part of this machine communicating with which the machine evaluation server that may also be a part of the arrangement. In this case the machine evaluation server may obtain the product specification data and send an instruction to the sensor device to provide an evaluation, where the instruction would then comprise technical performance data of the specification with which the evaluation is to be performed. The sensor device would then evaluate the performance based on operational data it has collected and provide an indication that is supplied to the machine evaluation server, which may announce the indication to the vendor.

Therefore the invention is only to be limited by the following claims.

1. A machine evaluation arrangement for providing an indication of the functioning of a machine, the machine evaluation arrangement comprising a machine evaluation device comprising a processor and a memory, said memory containing computer instructions executable by said processor whereby said machine evaluation device is operative to
obtain product specification data for the machine, said product specification data comprising technical performance data for the machine;
obtain operational data of the machine;
evaluate the technical performance of the machine with regard to the technical performance data of the specification, said technical performance of the machine being based on said operational data; and
provide an indication of the functioning of the machine based on the evaluation.

2. The machine evaluation arrangement according to claim 1, the machine evaluation device being further operative to process the operational data in order to obtain a value of the technical performance to be used in evaluating.

3. The machine evaluation arrangement according to claim 2, wherein there are various types of processing available for the evaluating and the machine evaluation device being further operative to choose at least one type of processing to be used in the evaluating.

4. The machine evaluation arrangement according to claim 3, the machine evaluation device being further operative to obtain a processing type selection from a provider of the product specification data and, when being operative to choose, is operative to choose said at least one type of processing based on the obtained processing type selection.

5. The machine evaluation arrangement according to any claim 2, where the machine evaluation device, when being operative to evaluate, is operative to compare the value of the technical performance with the technical performance of the specification.

6. The machine evaluation arrangement according to claim 5, where the machine evaluation device, when being operative to compare, is operative to determine a difference between the value of the technical performance of the machine and a value of the technical performance of the specification and to compare the difference with an allowed deviation, and when being operative to provide an indication of the functioning of the machine, is operative to provide an indication if the difference is an allowable difference or not.

7. The machine evaluation arrangement according to claim 6, the machine evaluation device being further operative to perform control of the machine if the indication is an indication that the difference is an unallowable difference.

8. The machine evaluation arrangement according to any claim 1, wherein the machine is a vehicle.

9. The machine evaluation arrangement according to any claim 1, wherein the machine is an e-health device.

10. The machine evaluation arrangement according to claim 1, wherein the technical data comprises measurements of at least one physical property of the machine and further comprising a measurement database in which the physical property measurements are stored.

11. The machine evaluation arrangement according to claim 1, further comprising an indication database and the machine evaluation device being further operative to store the indication in the indication database.

12. The machine evaluation arrangement according to claim 1, wherein the machine evaluation device is a machine evaluation server.

13. The machine evaluation arrangement according to claim 1, wherein the machine evaluation device is a sensor device associated with the machine.

14. A method for providing an indication of the functioning of a machine, the method being performed in a machine evaluation arrangement and comprising:
obtaining product specification data for the machine, said product specification data comprising technical performance data for the machine;
obtaining operational data of the machine;
evaluating the technical performance of the machine with regard to the technical performance data of the specification, said technical performance of the machine being based on said operational data; and
providing an indication of the functioning of the machine based on the evaluation.

15. The method according to claim 14, further comprising processing the operational data in order to obtain a value of the technical performance to be used in the evaluating.

16. The method according to claim 15, wherein there are various types of processing available for the evaluating and further comprising choosing at least one type of processing to be used in the evaluating.

17. The method according to claim 16, further comprising obtaining a processing type selection from a provider of the product specification data, where the choosing comprises choosing said at least one type of processing based on the obtained processing type selection.

18. The method according to claim 15, wherein the evaluation comprises comparing the value of the technical performance with the technical performance of the specification.

19. The method according to claim 18, wherein the comparing comprises determining a difference between the value of the technical performance of the machine and a value of the technical performance of the specification, and comparing the difference with an allowed deviation, and the providing of an indication of the functioning of the machine comprises providing an indication if the difference is an allowable difference or an unallowable difference.

20. The method according to claim 19, wherein, if the indication is an indication that the difference is an unallowable difference, then further performing control of the machine.

21. A computer program for providing an indication of the functioning of a machine, the computer program comprising computer program code which, when run in a machine evaluation device of a machine evaluation arrangement, causes the machine evaluation device to:
obtain product specification data for the machine, said product specification data comprising technical performance data for the machine;
obtain operational data of the machine;
evaluate the technical performance of the machine with regard to the technical performance data of the specification, said technical performance of the machine being based on said operational data; and
provide an indication of the functioning of the machine based on the evaluation.

22. A computer program product for providing an indication of the functioning of a machine, said computer program product being provided on a non-transitory data carrier and comprising said computer program code according to claim 21.
